(19) United States
(12) Patent Application Publication
(10) Pub. No.: US 2026/0027946 A1
(43) Pub. Date: Jan. 29, 2026

(54) PASSIVE DYNAMIC CELL BALANCING TECHNIQUES FOR ELECTRIFIED VEHICLES

(71) Applicant: FCA US LLC, Auburn Hills, MI (US)

(72) Inventor: Sundip Sharma Kongbrailatpam, Chennai (IN)

(21) Appl. No.: 18/780,940

(22) Filed: Jul. 23, 2024

(51) Int. Cl. B60L 58/22; B60L 58/16; H01M 10/42; H01M 10/48

(52) U.S. Cl. CPC B60L 58/22; B60L 58/16; H01M 10/425; H01M 10/482; H01M 10/486; B60L 2240/545; B60L 2240/547; H01M 2220/20

(57) ABSTRACT

A passive dynamic cell balancing system for an electrified vehicle includes a dynamic load system configured to vary a balancing current output to a battery system of the electrified vehicle, wherein the battery system comprises a plurality of battery cells, and a control system configured to estimate a charge imbalance across the plurality of battery cells by estimating a state of charge (SOC) of each of the plurality of battery cells, estimate a balancing current for each of the plurality of battery cells based on their respective estimated SOCs, and controlling the variable load system based on the estimated balancing currents to dissipate a desired amount of electrical energy from each of the plurality of battery cells to resolve the estimated charge imbalance.

### FIELD

The present application generally relates to electrified vehicles and, more particularly, to passive dynamic cell balancing techniques for electrified vehicles.

### BACKGROUND

An electrified vehicle includes a battery pack or system comprising a plurality of battery cells. The battery pack/system outputs electrical energy that could be used, for example, to power an electric traction motor for vehicle propulsion. Charge imbalance between the battery cells can occur over time and can lead to poor charging/discharging performance and potentially a decreased range for the electrified vehicle. There are two types of cell balancing: (1) active cell balancing, which is more costly/complex and involves discharging higher charged cells into lower charged cells, and (2) passive cell balancing, which is simpler and involves dissipating excess energy from higher charged cells to equal lower charged cells. Conventional passive cell balancing suffers from slow speeds and poor accuracy, primarily due to a fixed resistance that limits the discharge/balancing current. Accordingly, while such conventional electrified vehicle passive cell balancing techniques do work for their intended purpose, there exists an opportunity for improvement in the relevant art.

### SUMMARY

According to one example aspect of the invention, a passive dynamic cell balancing system for an electrified vehicle is presented. In one exemplary implementation, the passive dynamic cell balancing system comprises a dynamic load system configured to vary a balancing current output to a battery system of the electrified vehicle, wherein the battery system comprises a plurality of battery cells and a control system configured to estimate a charge imbalance across the plurality of battery cells by estimating a state of charge (SOC) of each of the plurality of battery cells, estimate a balancing current for each of the plurality of battery cells based on their respective estimated SOCs, and controlling the variable load system based on the estimated balancing currents to dissipate a desired amount of electrical energy from each of the plurality of battery cells to resolve the estimated charge imbalance.

In some implementations, the dynamic load system includes a switching mode dynamic load. In some implementations, the switching mode dynamic load is a variable shunt resistor and an electronically-controllable switching converter. In some implementations, the dynamic load system includes a linear dynamic load. In some implementations, the linear dynamic load is a power transistor operating in a linear mode. In some implementations, control system is further configured to determine an SOC deviation for each of the plurality of battery cells as a difference between the estimated SOC of the particular battery cell and a reference target SOC value, wherein the estimating of the plurality of estimated balancing currents is based on the respective SOC deviations. In some implementations, the control system is further configured to determine an SOC deviation for each of the plurality of battery cells based on a difference between a measured voltage of each of the plurality of battery cells and a reference target voltage value, wherein the estimating of the plurality of estimated balancing currents is based on the respective SOC deviations.

In some implementations, the control system is configured to estimate the plurality of estimated balancing currents based further on a state of health (SOH) of each of the plurality of battery cells and a temperature of each of the plurality of battery cells. In some implementations, the control system is configured to estimate the plurality of estimated balancing currents based further on a charging or discharging thermal status of each of the plurality of battery cells. In some implementations, the control system is further configured to selectively apply a variable gain to each of the plurality of estimated balancing currents to obtain a plurality of modified balancing currents, and wherein the control system is configured to control the dynamic load system based on the plurality of modified balancing currents to resolve the charge imbalance across the plurality of battery cells.

According to another example aspect of the invention, a passive dynamic cell balancing method for an electrified vehicle is presented. In one exemplary implementation, the passive dynamic cell balancing method comprises providing a dynamic load system vary a balancing current output to a battery system of the electrified vehicle, wherein the battery system comprises a plurality of battery cells, estimating, by a control system of the electrified vehicle, a charge imbalance across the plurality of battery cells by estimating an SOC of each of the plurality of battery cells, estimating, by the control system, a balancing current for each of the plurality of battery cells based on their respective estimated SOCs, and controlling, by the control system, the variable load system based on the estimated balancing currents to dissipate a desired amount of electrical energy from each of the plurality of battery cells to resolve the estimated charge imbalance.

In some implementations, the dynamic load system includes a switching mode dynamic load. In some implementations, the switching mode dynamic load is a variable shunt resistor and an electronically-controllable switching converter. In some implementations, the dynamic load system includes a linear dynamic load. In some implementations, the linear dynamic load is a power transistor operating in a linear mode. In some implementations, the method further comprises determining, by the control system, an SOC deviation for each of the plurality of battery cells as a difference between the estimated SOC of the particular battery cell and a reference target SOC value, wherein the estimating of the plurality of estimated balancing currents is based on the respective SOC deviations. In some implementations, the method further comprises determining, by the control system, an SOC deviation for each of the plurality of battery cells based on a difference between a measured voltage of each of the plurality of battery cells and a reference target voltage value, wherein the estimating of the plurality of estimated balancing currents is based on the respective SOC deviations.

In some implementations, the estimating of the plurality of estimated balancing currents based further on a SOH of each of the plurality of battery cells and a temperature of each of the plurality of battery cells. In some implementations, the estimating of the plurality of estimated balancing currents based further on a charging or discharging thermal status of each of the plurality of battery cells. In some implementations, the method further comprises selectively applying, by the control system, a variable gain to each of the plurality of estimated balancing currents to obtain a plurality of modified balancing currents, wherein the controlling of the dynamic load system to resolve the charge imbalance across the plurality of battery cells is performed based on the plurality of modified balancing currents.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having an example passive dynamic cell balancing system according to the principles of the present application;

FIG. 2 is a functional block diagram of an example architecture for the passive dynamic cell balancing system according to the principles of the present application; and

FIG. 3 is a flow diagram of an example passive dynamic cell balancing method for an electrified vehicle according to the principles of the present application.

### DESCRIPTION

As previously discussed, charge imbalance between battery cells of an electrified vehicle's battery pack or system can occur over time and can lead to poor charging/discharging performance and potentially a decreased range for the electrified vehicle. There are two types of cell balancing: (1) active cell balancing, which is more costly/complex and involves discharging higher charged cells into lower charged cells, and (2) passive cell balancing, which is simpler and involves dissipating excess energy from higher charged cells until they equal lower charged cells. Conventional passive cell balancing suffers from slow speeds and poor accuracy, primarily due to a fixed resistance that limits the discharge/balancing current. Accordingly, improved passive “dynamic” cell balancing techniques are presented herein that utilize a variable or dynamic load for controlling the cell balancing current. This dynamic load could be either a switching mode device (e.g., a manually-controllable variable shunt resistor and an electronically-controllable switching converter) or a linear dynamic load (e.g., a power transistor operating in a linear mode). Additional features to improve the performance of these passive dynamic cell balancing techniques include a unique state of charge (SOC) deviation detection, a unique balance current estimation method, and a variable gain to specify how quick/aggressive the cell balancing is to be performed. Potential benefits of these techniques include improved charge/discharge performance and an increased range of the electrified vehicle (e.g., up to ˜5 kilometers).

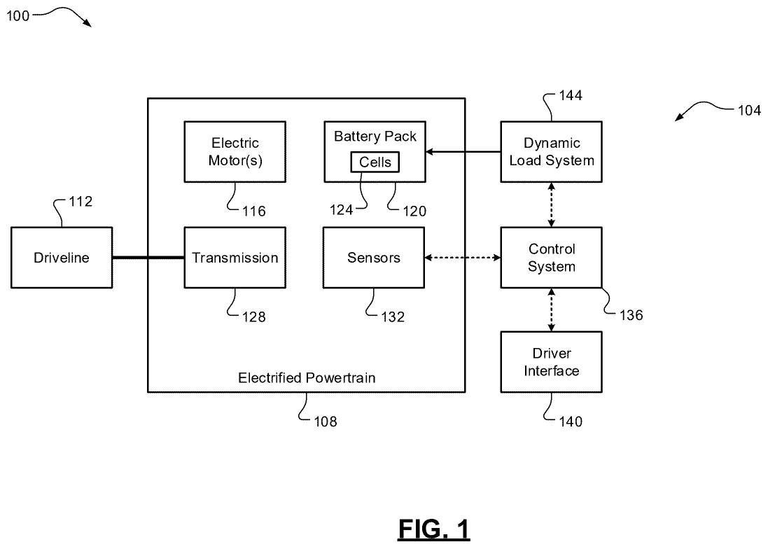

Referring now to FIG. 1, a functional block diagram of an electrified vehicle 100 having an example passive dynamic cell balancing system 104 according to the principles of the present application is illustrated. The electrified vehicle 100 comprises an electrified powertrain 108 configured to generate and transfer drive torque to a driveline 112 for vehicle propulsion. The electrified powertrain 108 includes, for example, one or more electric motors 116 powered by a high voltage battery pack or system 120 that includes a plurality of battery cells 124. For example only, the battery system 120 could include 96-108 battery cells 124 connected in series for a nominal voltage rating of approximately 400V. It will be appreciated that the high voltage system of the electrified powertrain 108 could include other non-illustrated components, such as high voltage contactors, a direct current to direct current (DC-DC) converter, and a three-phase inverter. The drive torque generated by the electric motor(s) 116 is transferred to the driveline 112 either directly or via a transmission, such as a multi-speed automatic transmission or a continuously variable transmission (CVT). While not shown, it will be appreciated that the electrified powertrain 108 could also include an optional internal combustion engine configured to combust a fuel/air mixture to generate mechanical energy that is used to power the driveline 112 and/or converted into electrical energy for recharging the battery system 120 or for powering accessory loads.

A plurality of sensors are configured to measure operating parameters of the electrified powertrain 108, including, but not limited to, speeds, torques, pressures, temperatures, and electrical parameters (voltage, current, etc.). A control system 136 is configured to control operation of the electrified vehicle 100. This primarily includes controlling the electrified powertrain 108 to generate a desired amount of drive torque to satisfy a driver torque request received via a driver interface 140 (e.g., an accelerator pedal). The control system 136 is also configured to control aspects of the passive dynamic cell balancing techniques of the present application, and thus the control system 136 and a dynamic load system 144 could form the passive dynamic cell balancing system 104. This generally includes the control system 136 estimating the SOCs of each of the plurality of battery cells 124 and then determining a charge imbalance across the plurality of battery cells 124. The control system 136 then estimates balancing currents based on the SOC deviations (from an SOC reference/target) and other parameters (cell state of health (SOH), thermal statuses, etc.) and controls the dynamic load system 144 based on the estimated balancing currents to dissipate a desired amount of electrical energy from each of the plurality of battery cells 124 to resolve the charge imbalance. This process and an example architecture of the control system 136 will now be discussed in greater detail.

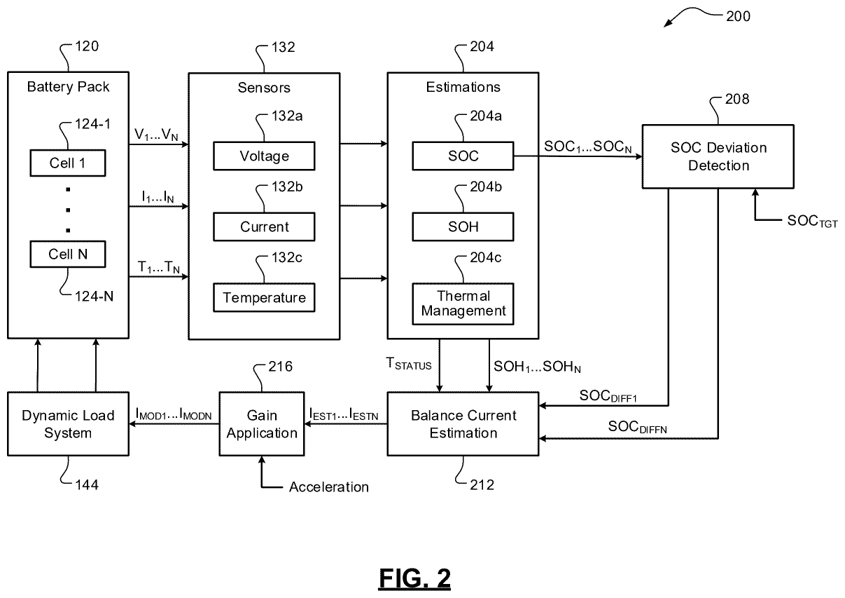

Referring now to FIG. 2 and with continued reference to FIG. 1, a functional block diagram of an example architecture 200 for the passive dynamic cell balancing system 104 according to the principles of the present application is illustrated. As shown, the battery pack or system 120 includes a plurality of battery cells 124-1 . . . 124-N (N>1; collectively, “battery cells 124”). The sensors 132 include voltage, current, and temperature sensors 132a, 132b, and 132c that measure voltage, current, and temperature of each of the plurality of battery cells 124 (V₁ . . . V_{N}, I₁ . . . I_{N}, and T₁ . . . T_{N}). Based on these measurements, other parameters are modeled or estimated, including SOC, SOH, and thermal management statuses (e.g., charging or discharging state) by a plurality of estimators of estimator or estimation block 204. The SOC estimation 204a could be performed, for example, using any suitable SOC estimation method such as a Kalman filter based estimation. The SOH estimation 204b could performed using any suitable SOH estimation or modeling technique. The measured parameters from the sensors 132 are also indicative of the charging/discharging state (determined by thermal management estimator 204c) of each of the plurality of battery cells 124.

The estimated SOCs SOC₁ . . . SOC_{N} for the plurality of battery cells 124 are output to an SOC deviation detector or detection block 208. The SOC deviation detection block 208 calculates an SOC deviation for each of the plurality of estimated SOCs. This is calculated by calculating a difference between a reference or target value (SOC_{TGT}) and the respective estimated SOC value. The SOC target SOC_{TGT} could be provided by a control logic block and could be determined, for example only, based on operating parameters of the electrified powertrain 108. It will be appreciated that the SOC deviation determination could also be cell voltage based. More specifically, in one example implementation, the SOC deviations could be determined based on a difference between a voltage of each of the plurality of battery cells 124 and a reference voltage. The SOC deviations SOC_{DIFF1} . . . SOC_{DIFFN} are output to a balance current estimator or estimation block 212. The balance current estimation block 212 also receives the estimated SOHs SOH₁ . . . SOH_{N} and the thermal statuses (e.g., charging/discharging) from the estimators 204b, 204c of the estimation block 204. The balance current estimation block 212 is configured to utilize these inputs to estimate balancing currents I_{EST1} . . . I_{ESTN} for each of the plurality of battery cells 124. An optional gain applicator or application block 216 could be implemented to apply variable gain to each of the plurality of estimated balancing currents I_{ST1} . . . I_{ESTN} to obtain modified balancing currents I_{MOD1} . . . I_{MODN}. This gain application block 216 could be further controlled by an acceleration factor or input (from the same control logic as the SOC target SOC_{TGT}) to vary how fast the passive dynamic cell balancing is performed. For example, by increasing the gain to increase the modified balancing currents and the passive dynamic cell balancing process, a quicker balancing operation could be achieved when needed.

The dynamic load system 144 receives either the estimated balancing currents or, when the gain application block 216 is present, the modified balancing currents. The dynamic load system is configured to vary the balancing current dissipated from each of the plurality of battery cells 124 to resolve the charge imbalance thereacross, which would be unable to be performed using a conventional fixed resistor or resistance system. The dynamic load system 144 generally comprises a power converter, a current sensor, and a resistive load. In a first embodiment, the dynamic load system 144 includes a switching mode dynamic load. The switching mode dynamic load generally comprises a switching converter (e.g., a buck converter) configured in a constant current mode, and a resistive load to dissipate energy and a current sensor to monitor the current. In one exemplary implementation, the switching mode dynamic load includes a manually-configurable variable shunt resistor (e.g., initially set by a human operator) and an electronically-controllable switching converter. In some implementations, the switching mode dynamic load only includes the switching converter (e.g., plus a fixed resistor). In a second embodiment, the dynamic load system 144 includes a linear dynamic load. In one exemplary implementation, the linear dynamic load is a power transistor operating in a linear mode to dissipate power. By controlling the dynamic load system 144, a desired amount of electrical energy is dissipated from each of the plurality of battery cells 124 to resolve the charge imbalance.

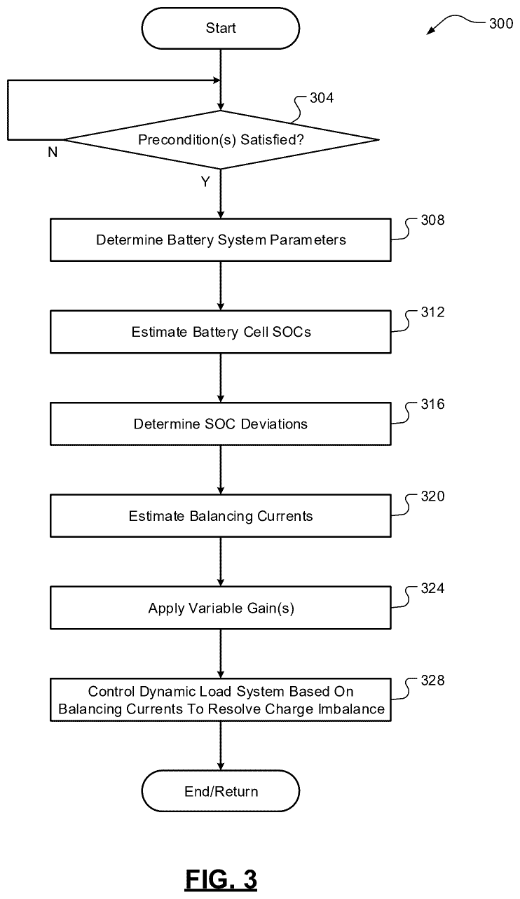

Referring now to FIG. 3, a flow diagram of an example passive dynamic cell balancing method 300 for an electrified vehicle according to the principles of the present application is illustrated. While the components of the electrified vehicle 100 and the architecture 200 are specifically referenced for illustrative/descriptive purposes, it will be appreciated that the method 300 could be applicable to any suitably configured electrified vehicle. The method 300 begins at 304 where an optional determination is made to see whether a set of one or more preconditions are satisfied. This could include, for example only, the electrified vehicle 100 having no malfunctions or faults present that would negatively impact or otherwise inhibit the operation of the passive dynamic cell balancing techniques of the present application. When false, the method 300 ends or returns to 304. When true, the method 300 proceeds to 308. At 308, the control system 136 determines or obtains measured operating parameters of the battery system 120 (voltage, current, temperature, etc.). At 312, the control system 136 estimated the SOCs of each of the plurality of battery cells 124. At 316, the control system 136 determines an SOC deviation from a reference or target SOC SOC_{TGT} for each of the plurality of battery cells 124. At 320, the control system 136 estimates balancing currents for the plurality of battery cells 124 based on the SOC deviations and, optionally, based further on other parameters such as the SOHs and thermal statuses of the plurality of battery cells 124. At 324, the control system 136 optionally applies a variable load to the plurality of estimated balancing currents (e.g., based on an acceleration input) to obtain a plurality of modified balancing currents. At 328, the control system 136 controls the variable load system 144 based on the plurality of estimated (or modified) balancing currents to dissipate a desired amount of electrical energy from each of the plurality of battery cells 124 to resolve the charge imbalance thereacross. The battery system 120 could then, for example, be recharged to a maximum/optimum level because the battery cells 124 have been balanced. The method 300 then ends or returns to 304 for another cycle.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A passive dynamic cell balancing system for an electrified vehicle, the passive dynamic cell balancing system comprising:
a dynamic load system configured to vary a balancing current output to a battery system of the electrified vehicle, wherein the battery system comprises a plurality of battery cells; and
a control system configured to:
estimate a charge imbalance across the plurality of battery cells by estimating a state of charge (SOC) of each of the plurality of battery cells;
estimate a balancing current for each of the plurality of battery cells based on their respective estimated SOCs; and
control the variable load system based on the estimated balancing currents to dissipate a desired amount of electrical energy from each of the plurality of battery cells to resolve the estimated charge imbalance.

2. The passive dynamic cell balancing system of claim 1, wherein the dynamic load system includes a switching mode dynamic load.

3. The passive dynamic cell balancing system of claim 2, wherein the switching mode dynamic load is a variable shunt resistor and an electronically-controllable switching converter.

4. The passive dynamic cell balancing system of claim 1, wherein the dynamic load system includes a linear dynamic load.

5. The passive dynamic cell balancing system of claim 4, wherein the linear dynamic load is a power transistor operating in a linear mode.

6. The passive dynamic cell balancing system of claim 1, wherein the control system is further configured to determine an SOC deviation for each of the plurality of battery cells as a difference between the estimated SOC of the particular battery cell and a reference target SOC value, wherein the estimating of the plurality of estimated balancing currents is based on the respective SOC deviations.

7. The passive dynamic cell balancing system of claim 1, wherein the control system is further configured to determine an SOC deviation for each of the plurality of battery cells based on a difference between a measured voltage of each of the plurality of battery cells and a reference target voltage value, wherein the estimating of the plurality of estimated balancing currents is based on the respective SOC deviations.

8. The passive dynamic cell balancing system of claim 1, wherein the control system is configured to estimate the plurality of estimated balancing currents based further on a state of health (SOH) of each of the plurality of battery cells and a temperature of each of the plurality of battery cells.

9. The passive dynamic cell balancing system of claim 8, wherein the control system is configured to estimate the plurality of estimated balancing currents based further on a charging or discharging thermal status of each of the plurality of battery cells.

10. The passive dynamic cell balancing system of claim 1, wherein the control system is further configured to selectively apply a variable gain to each of the plurality of estimated balancing currents to obtain a plurality of modified balancing currents, and wherein the control system is configured to control the dynamic load system based on the plurality of modified balancing currents to resolve the charge imbalance across the plurality of battery cells.

11. A passive dynamic cell balancing method for an electrified vehicle, the passive dynamic cell balancing method comprising:
providing a dynamic load system vary a balancing current output to a battery system of the electrified vehicle, wherein the battery system comprises a plurality of battery cells;
estimating, by a control system of the electrified vehicle, a charge imbalance across the plurality of battery cells by estimating a state of charge (SOC) of each of the plurality of battery cells;
estimating, by the control system, a balancing current for each of the plurality of battery cells based on their respective estimated SOCs; and
controlling, by the control system, the variable load system based on the estimated balancing currents to dissipate a desired amount of electrical energy from each of the plurality of battery cells to resolve the estimated charge imbalance.

12. The passive dynamic cell balancing method of claim 11, wherein the dynamic load system includes a switching mode dynamic load.

13. The passive dynamic cell balancing method of claim 12, wherein the switching mode dynamic load is a variable shunt resistor and an electronically-controllable switching converter.

14. The passive dynamic cell balancing method of claim 11, wherein the dynamic load system includes a linear dynamic load.

15. The passive dynamic cell balancing method of claim 14, wherein the linear dynamic load is a power transistor operating in a linear mode.

16. The passive dynamic cell balancing method of claim 11, further comprising determining, by the control system, an SOC deviation for each of the plurality of battery cells as a difference between the estimated SOC of the particular battery cell and a reference target SOC value, wherein the estimating of the plurality of estimated balancing currents is based on the respective SOC deviations.

17. The passive dynamic cell balancing system of claim 11, further comprising determining, by the control system, an SOC deviation for each of the plurality of battery cells based on a difference between a measured voltage of each of the plurality of battery cells and a reference target voltage value, wherein the estimating of the plurality of estimated balancing currents is based on the respective SOC deviations.

18. The passive dynamic cell balancing method of claim 11, wherein the estimating of the plurality of estimated balancing currents based further on a state of health (SOH) of each of the plurality of battery cells and a temperature of each of the plurality of battery cells.

19. The passive dynamic cell balancing method of claim 18, wherein the estimating of the plurality of estimated balancing currents based further on a charging or discharging thermal status of each of the plurality of battery cells.

20. The passive dynamic cell balancing method of claim 11, further comprising selectively applying, by the control system, a variable gain to each of the plurality of estimated balancing currents to obtain a plurality of modified balancing currents, wherein the controlling of the dynamic load system to resolve the charge imbalance across the plurality of battery cells is performed based on the plurality of modified balancing currents.
